(19) United States
(12) Patent Application Publication
(10) Pub. No.: US 2026/0274411 A1
(43) Pub. Date: Sep. 17, 2026

(54) SYSTEM AND METHOD FOR GROUND OBJECTS MANIPULATION USING A DRONE

(71) Applicant: XTEND Reality Expansion Ltd., Tel Aviv (IL)

(72) Inventors: Reuven Rubi Liani, Rosh Haayin (IL); Aviv Shapira, Tel Aviv (IL); Vittorio Zaidman, Rehovot (IL); Erez Nehama, Ramat Gan (IL); Eran Roll, Tel Aviv (IL)

(21) Appl. No.: 19/674,774

(22) Filed: May 12, 2026

Related U.S. Application Data
(63) Continuation of application No. 17/895,143, filed on Aug. 25, 2022.
(60) Provisional application No. 63/237,134, filed on Aug. 25, 2021.

(51) Int. Cl. B64C 39/02; B64U 101/60; G05D 1/00; H04N 7/18

(52) U.S. Cl. CPC B64C 39/024; G05D 1/223; G05D 1/2235; G05D 1/689; H04N 7/185; B64U 2101/60; B64U 2201/20

(57) ABSTRACT

The present invention relates to a system and method for ground object manipulation using a drone (UAV). The drone is configured with the camera(s) facing downwards to capture a real-time video feed of a top view of an AOI, which is then transmitted to the display screen of the mobile device associated with a user. The video feed is displayed on the display screen, which facilitates the user to use a marker on the display screen to select a target 2D location (object) in the AOI. The user can then operate a trigger of the remote controller to start the movement of the drone. The system then determines an optimal target velocity command for the drone to reach the selected target location, and automatically maneuvers the drone to the target location at the target velocity, and converges the drone around the desired target. The vertical movement of the drone above the target location is then controlled using the controller. The drone includes a motorized arm to grab/release the target objects.

### CROSS REFERENCE TO RELATED APPLICATIONS

This application is a Continuation of application Ser. No. 17/895,143, filed on Aug. 25, 2022, which claims priority under 35 U.S.C. § 119(e) to U.S. Provisional Application No. 63/237,134, filed on Aug. 25, 2021, all of which are hereby expressly incorporated by reference into the present application.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

Embodiments of the present invention generally relate to the field of Unmanned Aerial Vehicle (UAV). In particular, embodiments of the present invention relate to a system and method to enable remote and accurate maneuvering and converging of drones or UAVs around a target location, which allows users to control the drone while looking down and manipulate ground objects at the target location with high accuracy and ease.

Unmanned Aerial Vehicles (UAV)s commonly known as drones are widely used in various military, civil, and commercial applications including aerial photography, agriculture, policing and surveillance, product deliveries, and the likes. Drones are remotely controlled by users, which allows them to remotely and safely maneuver and control the drones from a distant location. Existing systems and methods for remotely controlling and maneuvering drones at an area of interest (AOI) generally involve the use of a remote controller or mobile devices in communication with the drones through a ground control station (GCS) to control the drones. Further, the camera(s) associated with the drones transmits a live video feed of the area of interest, which then transmits the live video feed to the display screen of the mobile device or other display devices associated with the user. The received video feed facilitates the users to accordingly operate the remote controller or the mobile device to control and maneuver the drones from the remote location.

In existing drones, the camera(s) are generally positioned at the front of the drones which allows the user to fly the drones from the remote location while looking forward from its point of view in the AOI, using the controller and/or the mobile device. Further, in many applications, drones are configured with the camera(s) at the bottom to have a top view of the AOI, which is generally used for surveillance or monitoring applications. However, the existing systems and methods for remotely controlling and maneuvering drones do not allow users to control the drones with high accuracy and ease while looking down.

In many applications, the drones are used for transporting objects from one location to another, where the object is pre-attached to the drone before takeoff and then the drone is remotely operated by the user to fly the drone and transport the attached object to the desired location where the object is dropped off from the drone or manually removed from the drone by another user. However, the use of front cameras in existing drones, which provides a front point of view of the AOI to the user, restricts users to efficiently and accurately manipulate ground objects present below the drone.

In addition, the existing drones and systems are not capable of safely picking up and dropping off objects from the AOI with high accuracy and ease while the drones are already in a flying state. The existing drones and systems are not adaptive to the changeable weight of the objects to be lifted or transported, which makes the drone unstable while flying, making it difficult for the user to maneuver and control the drone along with the objects with accuracy and stability. Besides, it is also difficult for users to manually and precisely converge the drone over the target location or the object to be manipulated in the AOI using the remote controller or mobile devices, while simultaneously controlling the altitude and vertical velocity of the drone over the target object using the remote controller.

There is, therefore, a need to overcome the above shortcomings and provide a system and method to enable remote and accurate maneuvering and converging of UAVs or drones around a target location in an area of interest, which allows users to control the UAV while looking down and manipulate ground objects at the target location with high accuracy and ease.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a network diagram of the proposed system in accordance with an embodiment of the present invention.

FIG. 2 illustrates a block diagram of the proposed system in accordance with an embodiment of the present invention.

FIG. 3 illustrates a representation of drone or UAV architecture in accordance with an embodiment of the present invention.

FIG. 4 illustrates a representation of ground control station architecture in accordance with an embodiment of the present invention.

FIG. 5 illustrates an exemplary view of a remote controller for the drones in accordance with an embodiment of the present invention.

FIG. 6 illustrates an exemplary view of the display screen of the mobile device showing various ground objects in the AOI in accordance with an embodiment of the present invention.

FIG. 7 illustrates an exemplary flow diagram of the proposed method in accordance with an embodiment of the present invention

### DETAILED DESCRIPTION

Provided herein are exemplary embodiment and implementations of the proposed system and method for remote and accurate maneuvering and converging of UAVs around a target location. The system allows users to control the UAV while looking down and manipulate ground objects at the target location with high accuracy and ease.

The disclosed technology provides a system and method that enables a user to remotely maneuver and converge drones or UAVs around a target location (position) in an area of interest (AOI) with high accuracy while looking down. The drones are configured with the camera(s) facing downwards to capture a real-time video feed of a top view of the AOI, which then transmits the live video feed to the display screen of the mobile device or other display devices associated with the user. The received video feed being displayed on the display screen facilitates the users to use a marker on the display screen to select a target 2D location or object on the ground or AOI. Further, the user can then operate a trigger of the remote controller or mobile device to start the movement of the drone. Accordingly, the system determines an optimal target velocity command for the drone to reach the selected target location, and the drone automatically maneuvers and flies to the selected target location at the desired velocity, thus resulting in the convergence of the drone around the desired target with no effort.

In an embodiment, the system herein can determine the optimal target velocity command for the drone to reach the target location based on the distance between the target location selected on the display screen and the center of the display screen. Further, the target velocity can be based on the amount of pressure the user applies to the trigger of the remote controller to initiate the movement of the drone. This enables accurate speed control in high/low velocities for rapid convergence of the drone over the target location or object in the AOI.

In another embodiment, the system herein can allow the users to manually maneuver and control the drone using the remote controller or the mobile devices to reach the target location at the desired velocity using the top view video feed being displayed on the display screen of the mobile device of the user. However, once the drone reaches the target location, the drone automatically converges around the target location or object on the ground. Further, the altitude and vertical velocity of the drone above the target location or object in the AOI can be manually controlled by the user using the remote controller or mobile devices associated with the users who can be present at the AOI or a remote location far away from the AOI or target location.

The disclosed technology provides a system that enables remote maneuvering and converging of drones or UAVs around a target location in an area of interest (AOI) with high accuracy, and allows users to control the drone while looking down, and manipulate (pick up or drop) ground objects at the target location with high accuracy and ease. The drones are configured with a motorized arm to grab/release objects. Once the drone automatically or manually reaches above the target object or location, the system allows the user can use the remote controller or mobile device to vary or adjust the altitude and vertical velocity of the drone and further control the operation of the motorized arm, which allows easier pick-up or drop-off of the object at the target location. The drone is adaptive to the changeable weight of the objects to be manipulated, thus only minor movements are caused while lifting the object, and the drone itself restores its stability.

In an embodiment, the system herein can allow the user to grab/lift or manually attach an object to the drone at a first location. The system can further allow the users to use a marker on the display screen to select a target 2D location or object on the ground or AOI. The user can then operate a trigger of the remote controller or mobile device to start the movement of the drone along with the object from the first location to the target location. Accordingly, the system determines an optimal target velocity command for the drone to reach the selected target location from the first location, and the drone along with the object automatically maneuvers and flies to the target location at the target velocity and converges around the desired target with no effort. Finally, the user can use the remote controller or mobile device to vary or adjust the altitude and vertical velocity of the drone once the drone reaches above the target object or location and further control the operation of the motorized arm to safely drop or place the object at the target location.

In an embodiment, the drones can have the capability to travel in space physically and precisely (3D environments) to reach the target location, along with the objects. The drones can be sized, adapted, and configured to be able to continually monitor the weight of the object attached to it, and compare the location of the drones in physical space to the precise point in the target location via proprietary sensor fusion algorithms that allow the drones to estimate the drone's temporospatial position with great accuracy in variable indoor and outdoor environments. Thus, allowing a minimally trained operator to operate and control the drone with great accuracy.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

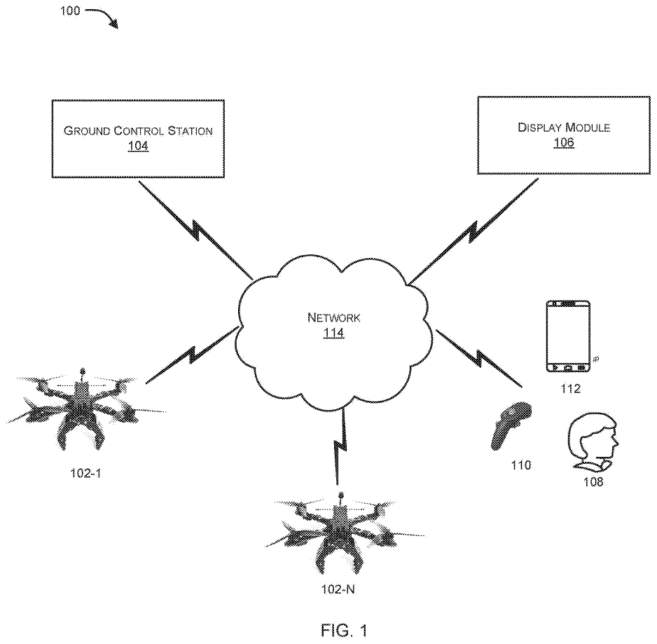

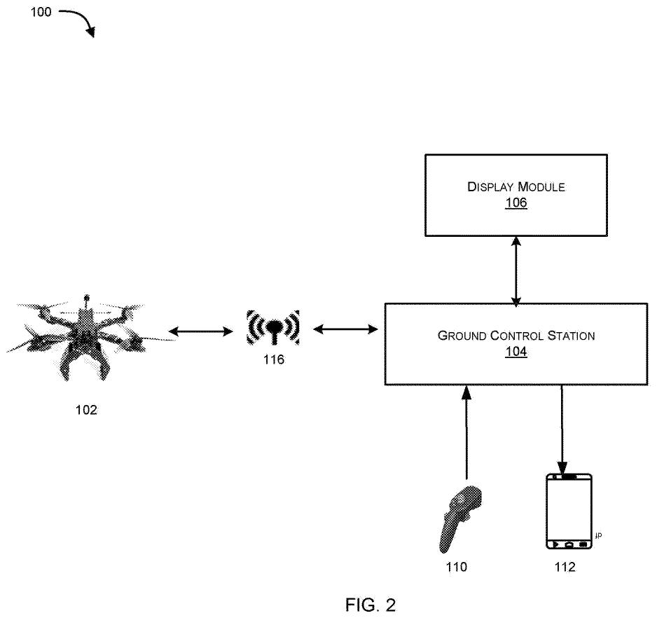

As illustrated in FIGS. 1 and 2, the proposed system 100 can include a ground control station (GCS) 104 (also referred to as central processing module (CPM) 104, herein). The GCS 102 can be communicatively coupled with one or more UAVs 102 (individually referred to as UAV 102 or drone 102, herein), a display module 106, and a remote controller 110 (also referred to as controller 110, herein), and a mobile device or HMD 112 associated with user 108 through a network 114. The GCS 104 can directly communicate with the UAV 102, and can further allow interaction and communication of the UAV 102 with remote controller 110, and mobile devices or HMD 112. Further, users 108 associated with the GCS 104 can remotely control the UAVs at an area of interest (AOI) or dynamic locations. When users 108 operate the UAV at the AOI, the GCS 104 can facilitate users 104 in controlling the UAV 102 using the controller 110 or mobile device 112. In an implementation, system 100 can be accessed using a virtual private network (VPN) or a server that can be configured with any operating system to provide secure communication in the system 100.

The controller 110 or mobile devices 112 associated with the user 108 can communicate with the UAV 102, and the GCS 104 through the network 114 regarding the controlled operation of the UAV 102 and ground objects manipulation in the AOI by the users 108 from a remote location. Further, users 108 present at a remote location or in the AOI can communicate with the UAV 102 to get the live video feed of a top view of the AOI, being captured by the drones, on the display screen of the mobile device or HMD 112, or display module 106 associated with the user 108, and accordingly, control the maneuvering and converging of the UAV 102 around a target location (position) or target objects in the AOI with high accuracy while looking down, and further allow users to manipulate (pick up or drop) ground objects at the target location with high accuracy and ease. In an exemplary embodiment, the mobile devices 112 can be smartphone, laptop, tablet, computer, and the likes.

In an implementation, the UAV 102 can be configured with the camera(s) facing downwards to capture a real-time video feed of a top view of the AOI, which then transmits the live video feed to the display screen of the mobile device 112 or other display devices associated with the user 108, through the GCS. The received video feed being displayed on the display screen of the mobile device 112 or display module 106 facilitates the user 108 to use a marker on the display screen to select a target 2D location or object on the ground or AOI. Further, user 108 can then operate a trigger of the remote controller 110 or mobile device 112 to start the movement of the UAV 102. Accordingly, the GCS 104 determines an optimal target velocity command for the UAV 102 to reach the selected target location, and the GCS 104 automatically maneuvers and flies the UAV 102 to the selected target location at the desired velocity, thus resulting in the convergence of the UAV 102 around the desired target with no effort.

System 100 can determine the optimal target velocity for the UAV 102 to reach the target location based on the distance between the target location selected on the display screen and the center of the display screen of the mobile device 112 or the display module 106. Further, the target velocity can be based on the amount of pressure the user applies to the trigger of the remote controller 110 to initiate the movement of the UAV 102. This enables accurate speed control in high/low velocities for rapid convergence of the UAV 102 over the target location or object in the AOI. For instance, if the user 108 selects the target location or object around the center of the display screen of the mobile device 112 with a gentle touch on the trigger of the controller 112, the GCS 104 can determine and select a target velocity of 0.5-1 kph for the UAV 102 to reach the target object. In another instance, if user 108 selects the target location or object around the edges of the display screen of the mobile device 112 with a full press on the trigger of the controller 112, the GCS 104 can determine and select a target velocity of 60-70 kph for the UAV 102 to reach the target object. As a result, the proposed system 100 facilitates high-velocity flight of the UAV 102 in the clear sky while looking down, and enables an “eagle eye” viewpoint during a flight over great distances, and further allows an accurate slow flight during stabilization of the UAV 102 over a specific location.

In another implementation, system 100 can allow the users 108 to manually maneuver and control the UAV 102 using the remote controller 110 or the mobile devices 112 to reach the target location at the desired velocity using the top view video feed being displayed on the display screen of the mobile device 112 or display module 108 of the user 108. However, once the UAV 102 reaches the target location, the GCS 104 can take control and can automatically converge the UAV 102 around the target location or object on the ground. Further, the altitude and vertical velocity of the UAV 102 above the target location or object in the AOI can be manually controlled by the user 108 using the remote controller 110 or mobile devices 112 associated with the users 108 who can be present at the AOI or a remote location far away from the AOI or target location.

System 100 can also allow users to control the UAV 102 while looking down, and manipulate (pick up or drop) ground objects at the target location with high accuracy and ease. The UAV 102 can be configured with a motorized arm to grab/release objects. Once the UAV 102 automatically or manually reaches above the target object or location, the GCS 104 can allow the user 108 to can use the remote controller 110 or mobile device 112 to vary or adjust the altitude and vertical velocity of the UAV 102 and further control the operation of the motorized arm, which allows easier pick-up or drop-off of the object at the target location. The UAV 102 can be adaptive to the changeable weight of the objects to be manipulated, which causes only minor movements while lifting the object, and the UAV 102 itself restores its stability.

In an implementation, system 100 can allow the user to grab/lift or manually attach an object to the UAV 102 at a first location. System 100 can further allow users 108 to use a marker on the display screen of the mobile device 112 to select a target 2D location or object on the ground or AOI. User 108 can then operate a trigger of the remote controller 110 or mobile device 112 to start the movement of the UAV 102 along with the object from the first location to the target location in the AOI. Accordingly, the GCS 104 can determine the optimal target velocity for the UAV 102 to reach the selected target location from the first location, and the UAV 102 along with the object can be automatically maneuvered and flown to the target location at the target velocity and can converge around the desired target with no effort. Finally, user 108 can use the remote controller 110 or mobile device 112 to vary or adjust the altitude and vertical velocity of the UAV 102 once the UAV 102 reaches above the target object or location and further control the operation of the motorized arm to safely drop or place the object at the target location.

System 100 can be implemented using any or a combination of hardware components and software components such as a cloud, a server, a computing system, a computing device, a network device, and the like. Further, the GCS 104 can communicatively interact with UAV 102, and remote controller 110, and mobile devices or HMD 112 associated with user 108 through a secured communication channel provided by communication units such as Wi-Fi, Bluetooth, Li-Fi, or an application, that can reside in the GCS 104, UAV 102, and remote controller 110, and mobile devices 112 associated with users 108. The system can include a transceiver 116 configured to create a two-way communication channel between the UAV 102, and the GCS 104. The components of the system can be communicatively coupled to each other through wireless data and video communication including Radio communication, digital communication, cellular communication, and the likes.

Further, network 114 can be a wireless network, or a combination of wired and wireless network, that can be implemented as one of the different types of networks, such as Intranet, Local Area Network (LAN), Wide Area Network (WAN), Internet, and the like. Further, network 114 can either be a dedicated network or a shared network. The shared network can represent an association of the different types of networks that can use a variety of protocols, for example, Hypertext Transfer Protocol (HTTP), Transmission Control Protocol/Internet Protocol (TCP/IP), Wireless Application Protocol (WAP), and the like.

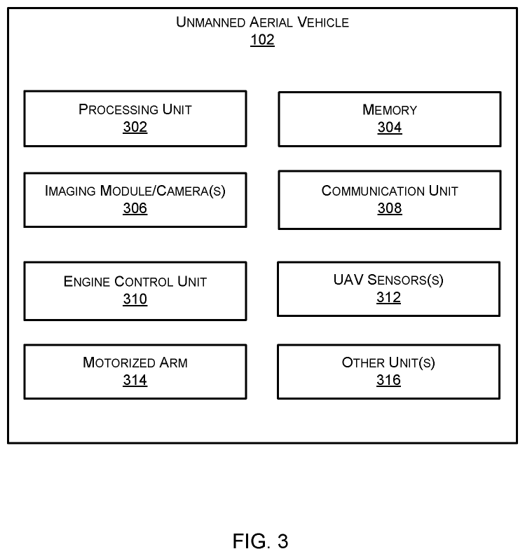

As illustrated in FIG. 3, the UAV architecture is illustrated. The UAV 102 can include a processing unit 302 comprising processors configured with a processor-readable memory 304 having thereon a set of executable instructions, configured, when executed, to cause the processor to operate the UAV 102, and enable communication between the UAV 102 and any or a combination of the GCS 104, remote controller 110, and mobile computing device. The UAV 102 can include an imaging module 306 comprising a camera(s) to capture a set of images (video feed) of an area of interest (AOI) at a predefined location. The UAV 102 can include a communication unit 308 that can be a Radio Frequency (RF) transceiver, WiFi Module, or cellular networks, but not limited to the likes. The communication unit 308 can be operatively coupled to the processing unit 302, and configured to communicatively couple the UAV 102 with GCS 104, remote controller 110, and mobile devices or HMD 112.

The camera(s) 306 of the UAV 102 can capture at least one real-time image or video feed of a top view of the AOI, and correspondingly generate and transmit a set of video signals to the GCS 104, which can then transmit the video feed to the display module 106 and mobile devices 112 associated with the user 108. The camera(s) 306 can further comprise analog camera(s), one or more digital cameras, charge-coupled devices (CCDs), a complementary metal-oxide-semiconductor (CMOS), or a combination comprising one or more of the foregoing. If static images are required, the camera can be a digital frame camera. The camera(s) 306 can be a night vision camera to allow the UAV 102 to capture video and provide a live feed of the predefined location at night or in low light conditions.

The UAV 102 can include an engine control unit 310 comprising engines, propellers, motors, and actuators, but not limited to the likes, operatively coupled to one another and the processing unit 302, to maneuver and operate the movement of the UAV 102. The engine control 310 unit can be operatively coupled to the processing unit 302, and configured to receive a set of control signals from any or a combination of the GCS 104, remote controller 110, and mobile devices 112, to instruct the engine control unit 310 to maneuver and operate the movement of the UAV 102 to reach the target location. The UAV 102 can stay or converge at a static target position in the AOI. The engine control unit 310 can further enable the adjustment of altitude and vertical velocity of the UAV 102 above the ground objects to be picked up or dropped at the target location.

The UAV 102 can further include a set of UAV sensors 312 (also referred to as UAV sensors 312, herein) along with the communication unit 308 to maintain two-way communication between the UAV 102, and GCS 104 and/or mobile device 112. The sensors 312 along with the cameras 306, can continually estimate and assess mismatch between the marked target position on the AOI, and the real position and speed of the UAV 102, performing sensor fusion and estimation, and continuously correcting the flight path to match the predetermined flight vector and speed. Sensors 312 can include a 12 degrees of freedom (DOF) sensor reference platform, pressure gauge(s), accelerometers, Lidars, ToF, Sonars, Accelerometers, Gyros, GPS, MonoCam SLAM, StereoCam SLAM. The implementation of the user experience and flight accuracy of the drones can be built upon a proprietary set of algorithms that allows creating both a static and progressive (machine learning, neural network) network of potentially endless sensors disposed on the drone itself and potentially within the flight route, used to adjust and correct the accuracy, precision and resolution of the UAV 102 in infinitely complex real-world environments, where each is characterized by different physical attributes such as light, texture, humidity, complexity, aerial pressure, physical barriers, shielding structures and so on. The fusion of the algorithm network is configured to gather and process the information gathered from the environment along the flight route and performs fusion & filtering and performs a prediction (estimation) of where it assesses the UAV's location and projected transformation (speed vector), and derives the necessary flight control commands needed to compensate between the target location as well as speed vector; and the estimated mismatch to that request. The algorithm networks can statically or dynamically improve the estimation by learning (dynamically) or configuring (statically) the weights (balance) between all active sensors to create the most accurate location and speed vector estimation, to continuously correct the flight path to reach the target location and converge around the target location, with or without the object.

The UAV 102 can further include a motorized arm 314 to grab/release ground objects. Once the UAV 102 automatically or manually reaches above the target object or location, the GCS 104 can allow the user 108 to use the remote controller 110 or mobile device 112 to vary or adjust the altitude and vertical velocity of the UAV 102 and further control the operation of the motorized arm 314, which enables easier pick-up or drop-off of the object at the target location. The processing unit 302 of the UAV 102 can transmit a set of actuation signals to the motorized arm 314, in response to a set of instructions received from the controller 110 or the GCS 104, which can enable the motorized arm 314 to grab or release the ground objects. The UAV 102 can be adaptive to the changeable weight of the objects to be manipulated, which causes only minor movements while lifting the object, and the UAV 102 itself restores its stability

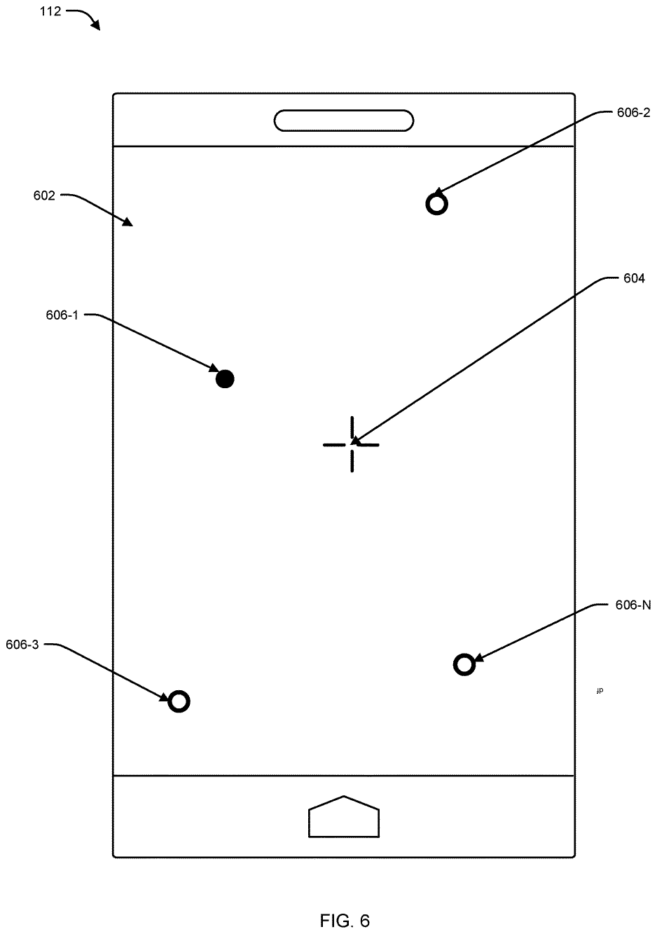

The other units 316 can include a video processing unit operatively coupled to the processing unit 302, and configured to decode or encrypt the images or videos captured by the camera(s) 306 of the UAV 102. The communication unit 308 can then transmit the decoded or encrypted video to the GCS 104, and/or display module 106 and/or mobile device or HMD 112, through the network 114, thereby enabling secure transmission of video signals between the UAV 102 and the GCS 104, and/or display module 106, mobile device or HMD 112. In an implementation, the video processing unit can generate a first marker corresponding to a current location of the UAV 102, and overlay the first marker on top of the video feed captured by the camera(s) 306 of the UAV 102. The current position of the UAV 102 in the AOI is displayed as a first marker 604 at the center of the display screen 602 of the mobile device 112 or display module 106 as shown in FIG. 6. Further, the communication unit 308 can transmit the decoded or encrypted video having the first marker overlaid on it, to the GCS 104, and/or display module 106, through the network 114.

The other units 316 of the UAV 102 can further include a telemetry Blackbox to store all the captured videos, and flight path data, but not limited to the likes. The UAV 102 can be configured with a global positioning system (GPS) module being operatively coupled to the processing unit 302, to monitor the real-time, precise, and accurate location of the UAV 102.

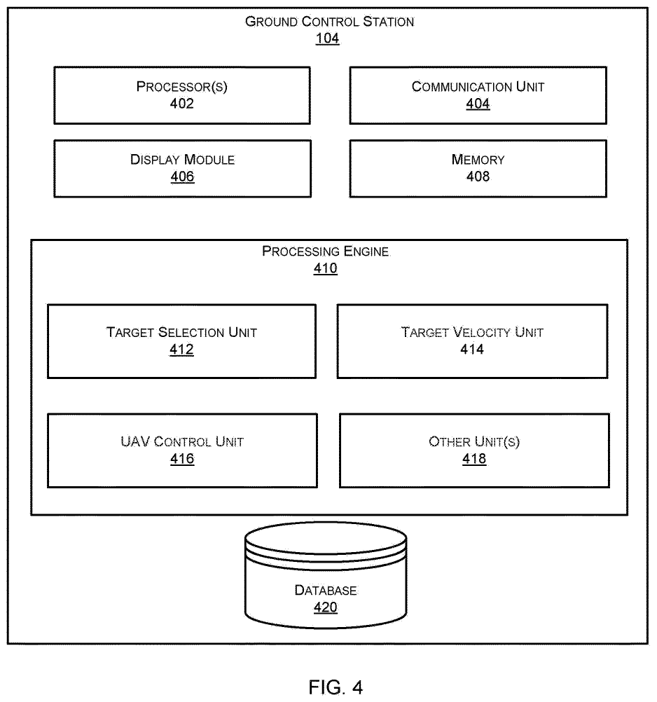

As illustrated in FIG. 4, the ground control station (GCS) 104 can include one or more processor(s) 402. The one or more processor(s) 104 can be implemented as one or more microprocessors, microcomputers, microcontrollers, digital signal processors, central processing units, logic circuitries, and/or any devices that manipulate data based on operational instructions. Among other capabilities, one or more processor(s) 402 are configured to fetch and execute a set of computer-readable instructions stored in a memory 408 of the GCS 104. The memory 408 can store one or more computer-readable instructions or routines, which may be fetched and executed to create or share the data over a network service. The memory 408 can include any non-transitory storage device including, for example, volatile memory such as RAM, or non-volatile memory such as EPROM, flash memory, and the like

The GCS 104 can include a communication unit 404, which can be a Radio Frequency (RF) transceiver, WIFI Module, but not limited to the likes. The communication unit 404 can be operatively coupled to the processors 402 and configured to communicatively couple the GCS 104 with the UAV 102, remote controller 110, mobile device or HMD 112, associated with the user. The GCS 104 can also include a display module 406 to provide live and/or recorded feed of video of the AOI, being captured by the cameras 306 of the UAV 102. The GCS 104 can also include an interface(s). The interface(s) can include a variety of interfaces, for example, interfaces for data input and output devices, referred to as I/O devices, storage devices, and the like. The interface(s) can facilitate communication between various one or more components of the GCS 104. The interface(s) can also provide a communication pathway for one or more components of the GCS 104. Examples of such components include, but are not limited to, processing engine(s) 410, communication unit 404, the display module 406, memory 408, and database 420 but not limited to the likes.

The processing engine(s) 410 can be implemented as a combination of hardware and programming (for example, programmable instructions) to implement one or more functionalities of the processing engine(s) 410. In examples described herein, such combinations of hardware and programming may be implemented in several different ways. For example, the programming for the processing engine(s) 410 may be processor-executable instructions stored on a non-transitory machine-readable storage medium, and the hardware for the processing engine(s) 410 may include a processing resource (for example, one or more processors), to execute such instructions. In the present examples, the machine-readable storage medium may store instructions that, when executed by the processing resource, implement the processing engine(s). In such examples, the GCS 104 can include the machine-readable storage medium storing the instructions and the processing resource to execute the instructions, or the machine-readable storage medium may be separate but accessible to GCS 104 and the processing resource. In other examples, the processing engine(s) 410 may be implemented by electronic circuitry. The memory 408 can include data that is either stored or generated as a result of functionalities implemented by any of the components of the processing engine(s) 410.

The processing engine(s) 410 can include a target selection unit 412, a target velocity unit 414, an UAV control unit 416, and other units(s) 418. The other unit(s) can implement functionalities that supplement applications or functions performed by the GCS 104 or the processing engine(s) 410.

The target selection unit 412 can enable the processor 402 to receive the real-time video feed of the AOI from the UAV 102, and transmit and display the video feed on a display screen of the mobile device 112 or display module 106. Further, upon selection of a 2D target location as a marker on the display screen by user 108, the target selection unit 412 can enable the processors 402 to determine the corresponding target location in the AOI where user 108 wishes the UAV 102 to reach and converge around. The target selection unit 412 can enable the processor 402 to overlay the selected or marked target location as a second marker on the video feed being displayed on the display screen. As shown in FIG. 6, the second marker 606-1 is the target object among multiple objects 606-1 to 606-N in the AOi at some distance from the current location of the drone that is represented as a first marker 604 at the center of the display screen 602 of the mobile device 112.

The target velocity unit 414 can enable the processor 402 to determine the optimal target velocity for the UAV 102 to reach the target location from the current location of the UAV in the AOI. The target velocity unit 414 can determine the optimal target velocity for the UAV 102 to reach the target location based on the distance between the target location selected on the display screen and the center of the display screen of the mobile device 112. Further, the target velocity unit 414 can enable the processor 402 to determine the target velocity for the UAV 102 based on the amount of pressure the user 108 applies to the trigger of the remote controller 110 to initiate the movement of the UAV 102. This enables accurate speed control in high/low velocities for rapid convergence of the UAV 102 over the target location or object in the AOI. For instance, referring to FIG. 6, if the user108 selects a target object 606-1 among multiple objects 606-1 to 606-N around the center 604 (current location of UAV) of the display screen 602 of the mobile device 112 with a gentle touch on the trigger of the controller 112, the target velocity unit selects a target velocity of 0.5-1 kph for the UAV 102 to reach the target object 606-1. In another instance, if user 108 selects a target object 606-3 around the edges of the display screen 602 of the mobile device 112 with a full press on the trigger of the controller 112, the target velocity unit can determine and select a target velocity of 60-70 kph for the UAV 102 to reach the target object 606-3.

The UAV control unit 416 can enable the processors 402 to transmit a set of first control signals to the UAV 102 based on the determined target location and target velocity for the UAV 102. The UAV 102, upon receiving the set of first control signals, can reach the marked target position at the AOI either automatically or using remote controller 110. The UAV control unit 416 can determine an optimum flight path for the UAV 102 to reach the target location. The UAV control unit 416 can enable the UAV 102 to travel in space (3D environments) physically and precisely to reach the target location in the AOI at the determined target velocity, and accurately maneuver at the AOI or converge the UAV 102 around the target location or ground object. The UAV 102 can be sized, adapted, and configured to be able to continually monitor the weight of the object attached to the UAV 102, and compare the location of the drones in physical space to the precise point in the target location via proprietary sensor fusion algorithms that allow the drones to estimate the UAV's temporospatial position with great accuracy in variable indoor and outdoor environments. Thus, allowing a minimally trained operator to operate and control the UAV 102 with great accuracy.

The UAV control unit 416 can enable the processors 402 to transmit a set of control signals to the UAV 102 to control the UAV 102, based on one or more flight control and maneuvering instructions provided by the user 108, using the remote controller 110 or mobile device 112. The GCS 104 can be configured to receive a set of commands signals corresponding to one or more flight control and maneuvering instructions and target location provided by the user 108, through the mobile device 112, and accordingly transmit the set of control signals to the UAV 102. Based on the set of control signals received, the engine control unit 310 of the UAV 102 can maneuver and fly the UAV 102 to reach and converge around the target location.

The display module 406 of the GCS 104 can include display elements, which may include any type of element which acts as a display. A typical example is a Liquid Crystal Display (LCD). LCD for example includes a transparent electrode plate arranged on each side of a liquid crystal. There are, however, many other forms of displays, for example, OLED displays and Bi-stable displays. New display technologies are also being developed constantly. Therefore, the term display should be interpreted widely and should not be associated with single display technology. Also, the display module may be mounted on a printed circuit board (PCB) of an electronic device, arranged within a protective housing, and the display module is protected from damage by a glass or plastic plate arranged over the display element and attached to the housing.

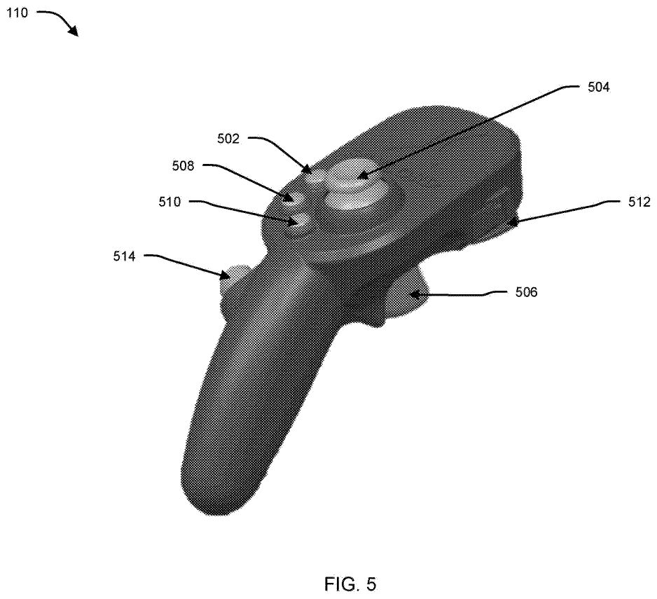

As illustrated in FIG. 5, the remote controller 110 for controlling the UAV 102 is disclosed. The remote controller 110 (also referred to as controller 110, herein) can include an RF transceiver to communicate with GCS 102, and UAV 102. The transceiver can allow the user to transmit a set of control signals to the UAV 102, to maneuver and converge the UAV 102, and perform vertical movement of the UAV 102 over the target object at the AOI.

The controller 110 can include a take-off button 110 to start and take off the UAV 102 towards the target location in the AOI, once the 2D target location is selected by the user on the display screen of the mobile device 112 or display module 106. The controller 110 can include a joystick 504 that can provide 6 degrees of freedom (DOF), but not limited to the like, to ascend/descend the drone and yaw the drone 104 above the target location or ground object. The controller 110 can include a Mark and Fly (MNF) button 508 that allows the user to fly the drone 104 in a mark and fly mode to automatically or semi-automatically navigate the UAV 102 to the selected target location. The controller 110 can include a trigger 506 that allows the user to control the speed of the drone 104. To maneuver the drone with MNF mode, the trigger 506 can be pulled to adjust the speed, and the controller 110 can be directed by controlled movement of the controller 110 by the user's hand, to adjust the heading of the drone 104.

In addition, upon marking the desired location, the GCS 102 can develop a flight plan and automatically maneuver the drone 104 to reach the desired location, and constantly converge around the target location. User 108 can press trigger 506 to increase the speed of the UAV 102 during automatic maneuvering also. The controller 110 can also include a landing button 510, which upon actuation by the user for a predefined time, can allow the drone 104 to automatically land or return to a docking station. Further, if required, an arm/disarm button 512 of controller 110 can be toggled to turn on/off the engines of the UAV 102. The UAV 102 can include a set of buttons 514, which upon actuation by the user, can trigger the motorized arm 314 of the UAV 102, to grab or release ground objects.

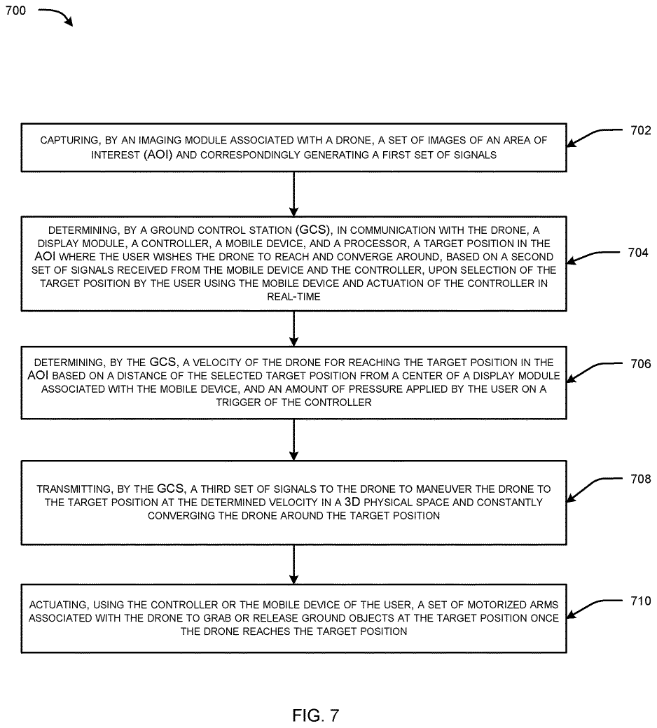

As illustrated in FIG. 7, an exemplary flow diagram of a method to enable remote and accurate maneuvering and converging of UAV 102 around a target location, which allows users 108 to control the UAV 102 while looking down and manipulate ground objects at the target location with high accuracy and ease is disclosed. Method 700 can include step 702 of capturing, by an imaging module 306 associated with a UAV 102, a set of images of an area of interest (AOI) and correspondingly generate and transmitting a first set of signals to a display module 106 or display screen of a mobile device 112 associated with a user 108 in real-time, which facilitates the user 108 to select the target position in the displayed set of images of the AOI. Method 700 can further include step 704 of determining, by a ground control station (GCS) 104 that is in communication with the UAV 102, the display module 106, a controller 110, mobile device 112, and a processor 402, a target position in the AOI where the user 108 wishes the UAV 102 to reach and converge around. The target position is determined based on a second set of signals received from the mobile device 112 and the controller 110, upon selection of the target position by the user 108 using the mobile device 112 and actuation of the controller 110 in real-time. Method 700 can further include step 706 of determining, by the GCS 104, a velocity of the UAV 102 for reaching the target position in the AOI based on a distance of the selected target position from a center of a display module associated with the mobile device 112, and an amount of pressure applied by the user 108 on a trigger of the controller 110. Accordingly, method 700 can include step 708 of transmitting, by the GCS 104, a third set of signals to the UAV 102 to maneuver the UAV 102 to the target position at the determined velocity of step 706 in a 3D physical space and constantly converging the UAV 102 around the target position. Once the UAV 102 reaches above the target location, user 108 can control the altitude and vertical velocity of the UAV 102 over the target position or the AOI using the controller 110 or the mobile device 112.

The method 700 can further include step 710 of actuating, using the controller 110 or the mobile device 112 of the user 108, a set of motorized arms 314 associated with the UAV 102 to grab or release ground objects at the target position once the UAV 102 reaches the target position at step 708.

In an aspect, the present disclosure elaborates upon system to facilitate ground object manipulation using a drone (UAV), the system comprising: a drone in communication with a mobile device and a controller associated with a user, the drone comprising an imaging module configured to capture a set of images of an area of interest (AOI) and correspondingly generate a first set of signals and a ground control station (GCS), in communication with the display module, the drone, the controller, the mobile device, and a processor, wherein the processor is in communication with a non-volatile memory comprising a processor-readable media having thereon a set of executable instructions, configured, when executed, to cause the processor to: determine a target position in the AOI where the user wishes the drone to reach and converge around, based on a second set of signals received from the mobile device and the controller, upon selection of the target position by the user using the mobile device and actuation of the controller in real-time; determine a velocity of the drone for reaching the target position in the AOI based on a distance of the selected target position from a center of a display module associated with the mobile device, and an amount of pressure applied by the user on a trigger of the controller; and transmit a third set of signals to the drone to maneuver the drone to the target position at the determined velocity in a 3D physical space and constantly converge the drone around the target position.

In an embodiment, the drone comprises a set of motorized arms configured to grab or release an object at the target position, upon actuation of any or a combination of the controller and the mobile device by the user.

In an embodiment, the drone is configured to receive a fourth set of signals generated by any or a combination of the controller, the mobile computing device, and the GCS, and correspondingly control the altitude and vertical velocity of the drone over the target position or the AOI.

In another aspect, the present disclosure elaborates upon a method for facilitating ground object manipulation using a drone, the method comprising the steps of: capturing, by an imaging module associated with a drone, a set of images of an area of interest (AOI) and correspondingly generating a first set of signals; determining, by a ground control station (GCS) comprising a processor, the GCS in communication with the drone, a display module, a controller, and a mobile device associated with a user, a target position in the AOI where the user wishes the drone to reach and converge around, based on a second set of signals received from the mobile device and the controller, upon selection of the target position by the user using the mobile device and actuation of the controller in real-time; determining, by the GCS, a velocity of the drone for reaching the target position in the AOI based on a distance of the selected target position from a center of a display module associated with the mobile device, and an amount of pressure applied by the user on a trigger of the controller; and transmitting, by the GCS, a third set of signals to the drone to maneuver the drone to the target position at the determined velocity in a 3D physical space and constantly converging the drone around the target position.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

1. A method to navigate a drone towards an area of interest (AOI), the method comprising:
a. transmitting environmental data comprising a set of images of the area of interest (AOI);
b. receiving a set of control signals, wherein the set of control signals comprise an optimal target velocity command and a direction;
c. scanning for an environmental parameter;
d. determining an optimum altitude based at least in part on the scanned environmental parameter and the set of control signals;
e. moving in the direction of the area of interest (AOI) at the determined optimum altitude.

2. The method of claim 1, further comprising:
a. activating a drone-attached motorized arm;
b. transmitting a set of images of an object of interest within a view of the area of
interest (AOI);
c. identifying the object of interest;
d. determining an approximate distance between a current position of the drone and the object of interest;
e. receiving a user-activated command to engage the object of interest with the drone-attached motorized arm; and
f. implementing the user-activated command to engage the object of interest.

3. The method of claim 2, wherein receiving a user-activated command to engage the object of interest with the drone-attached motorized arm is at least one of an open command, a close command, an approach command, an activate command, a release command, and a grip command.

4. The method of claim 2, further comprising determining a grip pressure based at least in part on the identity of the object of interest.

5. The method of claim 2, further comprising establishing communication between the drone and the object of interest.

6. The method of claim 2, further comprising determining a mass of the object of interest.

7. The method of claim 6, further comprising adjusting a degree of yaw to compensate for the sensed mass of the object of interest.
